(19) United States
(12) Patent Application Publication
(10) Pub. No.: US 2011/0113321 A1
(43) Pub. Date: May 12, 2011

(54) XPS FILE PRINT CONTROL METHOD AND PRINT CONTROL TERMINAL DEVICE

(75) Inventors: Young-soo HAN, Yongin-si (KR); Tae-woon JEONG, Suwon-si (KR)

(73) Assignee: Samsung Electronics Co., Ltd, Suwon-si (KR)

(21) Appl. No.: 12/908,432

(22) Filed: Oct. 20, 2010

(30) Foreign Application Priority Data
Nov. 9, 2009 (KR) 2009-107701

(51) Int. Cl. G06F 15/00; G06F 17/00

(52) U.S. Cl. 715/234; 358/1.15

(57) ABSTRACT

A print control method includes receiving a print command to print a document, receiving an input of document information regarding the document, generating a document information file using the input document information, generating an XML paper specification (XPS) file containing the document information using the generated document information file, and transmitting the generated XPS file to the image forming apparatus. Therefore, it is possible for a user to easily set the document information in the XPS file.

### CROSS-REFERENCE TO RELATED APPLICATIONS

This application claims the benefit under 35 U.S.C. §119(a) from Korean Patent Application No. 10-2009-0107701, filed on Nov. 9, 2009 in the Korean Intellectual Property Office, the disclosure of which is incorporated herein by reference in its entirety.

### BACKGROUND

1. Field of the Invention

The present general inventive concept relates to a print control method and a print control terminal device. More particularly, the present general inventive concept relates to a print control method and a print control terminal device to record document information on PrintTickets within an XML paper specification (XPS) file so that a user can easily search for a desired XPS file and that the XPS file can be printed.

2. Description of the Related Art

Image forming apparatuses generally print data generated by terminal devices, such as computers, onto recording media. Examples of such image forming apparatuses include copiers, printers, facsimile machines, and multifunction peripherals (MFPs) which combine functions of copiers, printers, and facsimile machines into a single system.

Image forming apparatuses which have been widely used in recent years have XPS emulators so as to support a function of printing XPS files, in addition to a conventional function of printing print data written in a page description language (PDL), such as postscript (PS) or printer command language (PCL).

An XPS file has a fixed-layout electronic file format that preserves document formatting and can be shared, and refers to a zip-formatted file which includes all kinds of data and resources described by systematizing all resources required for documents or operations in a directory structure and by writing the references therebetween in XML. In other words, a user may set a content and layout of a document and generate an XPS file based on the document. The XPS file of the document may have a content and layout that can be viewed but not changed.

Additionally, XPS files are based on the open packaging conventions (OPC) format having a ‘core properties’ part. The core properties part contains document information. However, a conventional driver (for example, a Win32 application) does not generate an XPS file having the core properties part, and even a Windows Presentation Foundation (WPF) application capable of generating an XPS file generates core properties containing only a part of document information items. Accordingly, it is not easy for users to perform jobs such as searching, indexing, or limiting in printing with respect to XPS files.

### SUMMARY

The present general inventive concept provides a print control method and a print control terminal device, in which document information is recorded on PrintTickets within an XML paper specification (XPS) file so that a user can easily search for a desired XPS file and the XPS file can be printed.

Additional features and utilities of the present general inventive concept will be set forth in part in the description which follows and, in part, will be obvious from the description, or may be learned by practice of the general inventive concept.

Features and/or utilities of the present general inventive concept can be achieved by a print control method in a print control terminal device connected to an image forming apparatus, the print control method including receiving a print command to print a document, receiving an input of document information regarding the document, generating a document information file using the input document information, generating an XML paper specification (XPS) file containing the document information using the generated document information file, and transmitting the generated XPS file to the image forming apparatus.

The receiving of the input of the document information may include displaying a plurality of document information items in the form of a list and receiving an input of document information regarding at least one item of the plurality of displayed document information items.

The receiving of the input of the document information may further include recognizing a document information item previously set in a document to which the print command is applied. The displaying of the plurality of document information items may include reflecting and displaying the recognized document information item on the list.

The receiving of the input of the document information may include receiving a hierarchical input of a plurality of document information items.

The generating of the document information file may include hierarchically generating a plurality of document information files to correspond to the plurality of hierarchically input document information items.

The generating of the XPS file may include adding the plurality of hierarchically generated document information files to one or more PrintTickets that correspond to one or more levels within the XPS file and generating the XPS file containing the document information.

The one or more levels may be a job level, a document level, and a page level.

The generating of the XPS file may include, if the print command is applied to a document other than the XPS file, converting the document into an XPS file and adding the generated document information file to the XPS file.

The print control method may further include storing the generated XPS file.

The print control method may further include receiving a document information condition specified by a user, and searching for a region of an XPS file which satisfies the document information condition.

The print control method may further include setting a print option selected by the user to the region found as a result of searching.

The transmitting of the generated XPS file may include setting the region found as a result of searching to be a print range and transmitting the generated XPS file to the image forming apparatus in the set print range.

The print control method may further include storing only the region found as a result of searching.

Features and/or utilities of the present general inventive concept can also be achieved by a print control terminal device connected to an image forming apparatus, the print control terminal device including a user interface unit to receive a print command to print a document and to receive an input of document information regarding the document, a document information file generator to generate a document information file using the input document information, an XML paper specification (XPS) file generator to generate an XPS file containing the document information using the generated document information file, and a communication interface unit to transmit the generated XPS file to the image forming apparatus.

The user interface unit may display a plurality of document information items in the form of a list, and may receive an input of document information regarding at least one item of the plurality of displayed document information items.

The user interface unit may recognize a document information item previously set in a document to which the print command is applied and may reflect and display the recognized document information item on the list.

The user interface unit may receive a hierarchical input of a plurality of document information items.

The document information file generator may hierarchically generate a plurality of document information files to correspond to the plurality of hierarchically input document information items.

The XPS file generator may add the plurality of hierarchically generated document information files to one or more PrintTickets that correspond to one or more levels within the XPS file and may generate the XPS file containing the document information.

The one or more levels may be a job level, a document level, and a page level.

If the print command is applied to a document other than the XPS file, the XPS file generator may convert the document into an XPS file. The XPS file generator may add the generated document information file to the XPS file.

The print control terminal device may further include a storage unit to store the generated XPS file.

The print control terminal device may further include a search unit to search for a region of an XPS file which satisfies a document information condition specified by a user.

The print control terminal device may further include a control unit to set a print option selected by the user to the region found as a result of searching.

The communication interface unit may set the region found as a result of searching to be a print range and may transmit the generated XPS file to the image forming apparatus in the set print range.

Features and/or utilities of the present general inventive concept may also be realized by a method of generating an XML paper specification (XPS) file, the method including receiving a command to generate an XPS file to display first data, after receiving the command, receiving second data to include in the XPS file, and generating an XPS file including the first data and the second data, such that the first data and the second data in the XPS file are not editable.

The first data may correspond to visible data when the XPS file is displayed, and the second data may correspond to hidden data when the XPS file is displayed.

Each of the first data and the second data may be searchable.

The XPS file may include a plurality of sub-documents, and the method may include receiving a user input to search the XPS file for hidden data corresponding to at least one of the sub-documents and performing one of a printing operation and a display operation of visual data of the XPS file corresponding to the at least one of the sub-documents.

Receiving the data to include in the XPS file may include displaying a user interface including a plurality of data entry fields and receiving a user input to insert the data into at least one of the plurality of data entry fields.

The plurality of data entry fields corresponds to a plurality of hierarchal levels of the XPS file.

Features and/or utilities of the present general inventive concept may also be realized by an XML paper specification (XPS) file generation terminal, including a user interface to receive data to display in an editable document, a controller to receive a command to generate an XPS file and, after receiving the command, to receive additional data to include in the XPS file, and an XPS file generator to generate an XPS file including visible data corresponding to the displayed data of the editable document and the additional data.

The XPS file generator may generate the XPS file to include a plurality of hierarchal levels, and each of the visible data and the additional data may include different data to correspond to different hierarchal levels of the plurality of hierarchal levels.

The XPS file generation terminal may include a communication interface to output the XPS file to an external device.

The controller may receive the additional data via the user interface.

The additional data may include at least one of a subject, keyword, or comment corresponding to the XPS file.

Features and/or utilities of the present general inventive concept may also be realized by an XML paper specification (XPS) file generation terminal, including a controller to receive a command to generate an XPS file and, after receiving the command, to receive additional data to include in the XPS file, and an XPS file generator to generate an XPS file including visible data corresponding to the print command and the additional data.

Features and/or utilities of the present general inventive concept may also be realized by a computing system, including a first terminal to receive a command to generate an XPS file to display original data, to receive additional data to include in the XPS file after receiving the first command, and to generate the XPS file including the original data and the additional data, and a display device connected to the first terminal to display the original data of the XPS file.

The display device may be a printer and the printer may print only the original data of the XPS file.

The display device may be a video display device to display only the original data of the XPS file.

The computing system may include a second terminal connected to the first terminal, the second terminal to receive the XPS file and including a display and at least one of the first terminal and the second terminal may include a search unit to fine at least one datum of the additional data based on a user input.

The at least one of the first and second terminal may include a communication interface unit to output an original datum corresponding to the at least one datum of the additional data to at least one of a printer and a video display device.

### BRIEF DESCRIPTION OF THE DRAWINGS

The above and/or other features and utilities of the present general inventive concept will become apparent and more readily appreciated from the following description of the embodiments, taken in conjunction with the accompanying drawings of which:

FIG. 1 illustrates a block diagram of a print control terminal device according to an exemplary embodiment of the present general inventive concept;

FIGS. 2 and 3 illustrate document information items;

FIGS. 4 and 5 illustrate document information files generated by a document information file generator shown in FIG. 1;

FIG. 6A illustrates a job-level PrintTicket before addition of document information;

FIG. 6B illustrates a job-level PrintTicket after addition of document information;

FIGS. 7 to 11 illustrate user interface windows according to an exemplary embodiment of the present general inventive concept;

FIGS. 12 and 13 are flowcharts illustrating a print control method according to an exemplary embodiment of the present general inventive concept;

FIG. 14 illustrates a logical structure of an XML paper specification (XPS) file;

FIG. 15 illustrates an XPS document generating system according to an embodiment of the present general inventive concept; and

FIGS. 16A and 16B illustrate block diagrams of XPS document generating systems according to embodiments of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The embodiments are described below to explain the present general inventive concept by referring to the figures.

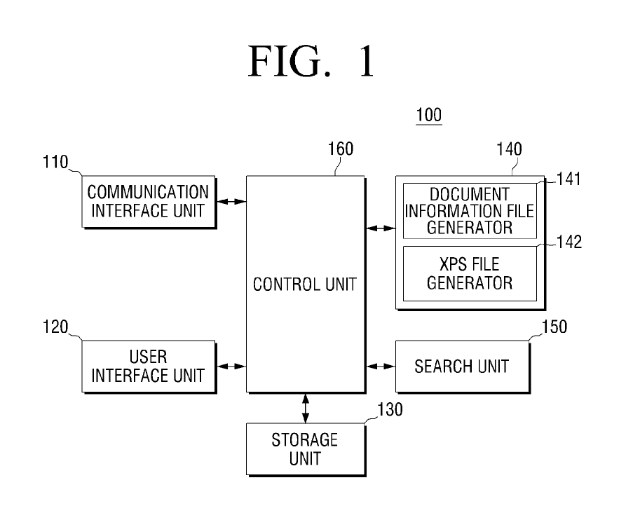

FIG. 1 illustrates a block diagram of a print control terminal device 100 according to an exemplary embodiment of the present general inventive concept. In FIG. 1, the print control terminal device 100 includes a communication interface unit 110, a user interface unit 120, a storage unit 130, a driver unit 140, a search unit 150 and a control unit 160.

The communication interface unit 110 may transmit a generated XML paper specification (XPS) file to an image forming apparatus (not illustrated). In more detail, the communication interface unit 110 may be connected to the image forming apparatus and may transmit an XPS file generated by the driver unit 140 that will be described below to the image forming apparatus. Additionally, the communication interface unit 110 may be configured to connect the print control terminal device 100 to an external apparatus and may be implemented as a parallel port, a universal serial bus (USB) port, a wireless module, and the like.

Here, the XPS file refers to print data for which print options are set and which is represented in the form of a hierarchical tree structure having a plurality of levels connected to corresponding nodes. Specifically, the XPS file has a plurality of levels each having one or more nodes, and different print options may be set for each node of the plurality of levels.

Referring to FIG. 14, an exemplary XPS file is represented as having a job level (Job Level PrintTicket) 10, a document level (Document Level PrintTicket) 20 and a page level (Page Level PrintTicket) 30 located in a hierarchical branching structure. Different print options may be set for each of a plurality of documents at the document level 20 and for each of a plurality of pages at the page level 30. For example, a “double-sided printing” option may be set for the job level 10; a “two pages per sheet (2-up)” option may be set for a first document 21 of the document level 20; an “A4 paper” option may be set for a first page 31 of the first document 21 at the page level 30; and an “A5 paper” option may be set for a second page 32 of the first document 21 at the page level 30. In this example, the print options set for the respective nodes of the tree are available at lower levels.

The user interface unit 120 includes a plurality of function keys through which a user is able to set or select various functions supported by the print control terminal device 100. The user interface unit 120 may display a variety of information provided by the print control terminal device 100. The user interface unit 120 may be implemented as an apparatus such as a touch pad, which is able to simultaneously implement input and output, or as an apparatus combining a mouse and a monitor, etc. A user may select a document to print using a user interface window provided by the user interface unit 120.

Additionally, the user interface unit 120 may display a user interface window through which a user is able to input document information regarding a current document, and may receive the document information from the user. In more detail, the user interface window provided by the user interface unit 120 may include a first field to display a plurality of document information items in the form of a list so as to receive information on the plurality of document information items input by the user and a second field to receive document information for each of the plurality of document information items input by the user.

In this situation, the user interface unit 120 may determine whether preset document information is contained in a document to which a print command is applied. The user interface unit 120 may display the preset document information on the user interface window by reflecting the preset document information on the list of the plurality of document information items upon determining that the preset document information is contained in the document. For example, if a user selects an open packaging conventions (OPS) document capable of containing document information, the user interface unit 120 may reflect and display document information items previously set in the OPC document on the user interface window. Additionally, the user interface unit 120 may display details pertaining to the document information among file information provided by an operating system (OS) on the list of the user interface window. The details may include, for example, information regarding the date and time when the document was last printed, the date and time when the document was last saved, and a user who last saved the document.

Furthermore, the user interface unit 120 may hierarchically receive the plurality of document information items input by the user. In more detail, since an XPS file has a hierarchical branching structure as described above, the document information may also be hierarchically reflected on the XPS file. Accordingly, the user interface unit 120 may hierarchically receive the plurality of document information items input by the user. For example, if an XPS file has two document levels, a user may enter a job level titled as ‘Korean weather’ and document levels, which are lower than the job level and titled as ‘summer weather’ and ‘winter weather,’ using the user interface unit 120.

The storage unit 130 may store an XPS file. In more detail, the storage unit 130 may store an XPS file generated by a user using an application program, or an XPS file generated by the previous process. The storage unit 130 may also store an XPS file generated by the driver unit 140 that will be described later. Additionally, the storage unit 130 may be implemented as a storage medium mounted in the print control terminal device 100 or as an external storage medium, for example a removable disk including a USB memory or a web server on a network.

The driver unit 140 may generate a document information file using the document information received through the user interface unit 120, and may generate an XPS file containing the generated document information file. In more detail, the driver unit 140 may include a document information file generator 141 and an XPS file generator 142. Additionally, the driver unit 140 may be implemented as an XPS printer driver to perform serial operations for an XPS file.

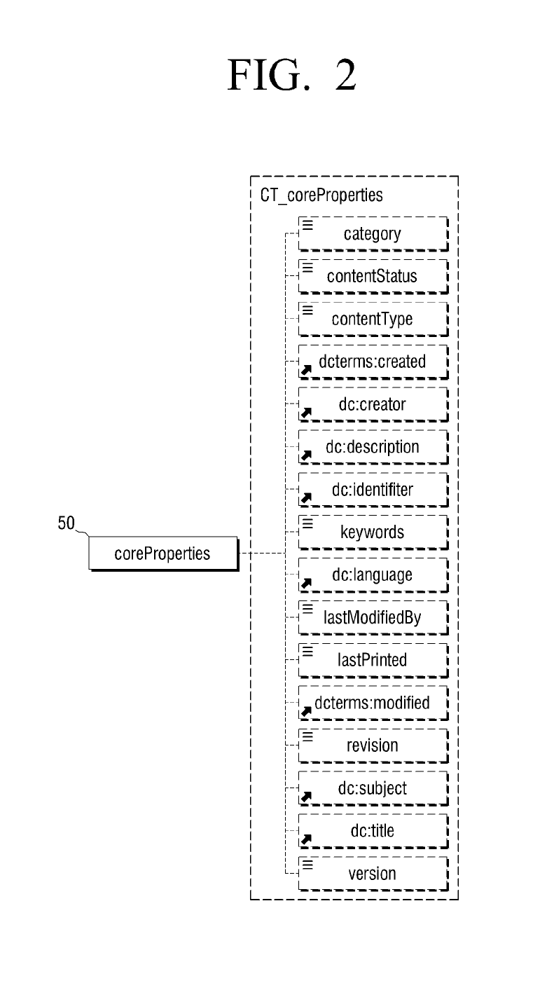

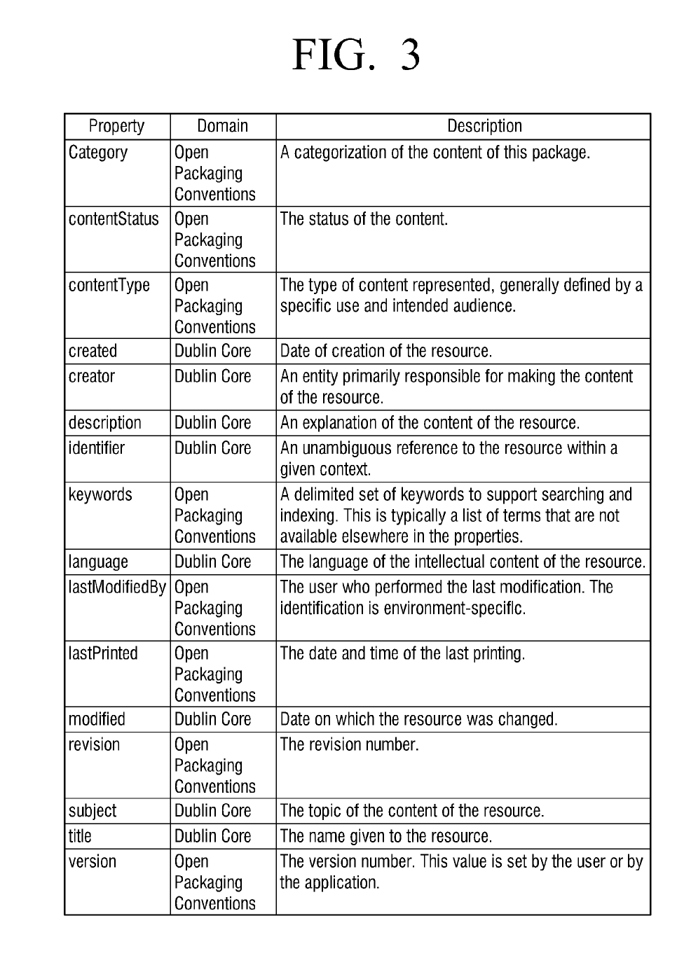

The document information file generator 141 may generate a document information file using the document information received through the user interface unit 120. More specifically, the document information file generator 141 may generate a core properties file containing document information input by a user. Herein, core properties refer to property information indicating document information within the OPC specification. Referring to FIG. 2, a core properties part 50 includes a plurality of document information items, each having information illustrated in FIG. 3.

Additionally, the document information file generator 141 may hierarchically generate document information files to correspond to the document information items hierarchically received through the user interface unit 120. In more detail, if a user hierarchically inputs document information, the document information file generator 141 may hierarchically classify the input document information, and may generate a plurality of document information files to correspond to each of the classified information. For example, if a user enters ‘Korean weather’ as a title for a job level and enters ‘summer weather’ and ‘winter weather’ as titles for lower document levels, the document information file generator 141 may generate a first document information file corresponding to the job level titled as ‘Korean weather’, a second document information file corresponding to the document level titled as ‘summer weather’ and a third document information file corresponding to the document level titled as ‘winter weather.’

The XPS file generator 142 may generate an XPS file containing the generated document information files. More specifically, if the print command is applied to an XPS file, the XPS file generator 142 may add the document information files generated by the document information file generator 141 to PrintTickets corresponding to one or more levels of the XPS file, and may generate an XPS file containing the document information. For example, if the document information file generator 141 generates a first document information file corresponding to the job level and a second document information file and third document information file corresponding to the document levels, the XPS file generator 142 may add document information of the first document information file, document information of the second document information file, and document information of the third document information file to a job-level PrintTicket 10, a first document-level PrintTicket 21, and a second document-level PrintTicket 22 within the XPS file, respectively.

If the XPS file does not contain PrintTicket corresponding to the document information file, the XPS file generator 142 may generate a PrintTicket corresponding to the document information file, and may add the document information of the document information file to the generated PrintTicket. For example, if a user inputs pages 5-6 as document information for the second document region, but if there is no second PrintTicket in the XPS file, the XPS file generator 142 may set pages 5-6 as another document level, and may generate a second PrintTicket 22 corresponding to the document level.

If the print command is applied to a document other than the XPS file, the XPS file generator 142 may convert the document into an XPS file, may perform the above-described process, and may add the document information of the document information file to a PrintTicket within the XPS file.

If the user does not hierarchically input document information, the document information file generator 141 may generate only a single document information file, and accordingly the XPS file generator 142 may add document information of the generated document information file to a job-level PrintTicket.

The document information file generator 141 and the XPS file generator 142 are two different constituents as shown in FIG. 1, but may be combined in a single constituent. Additionally, the document information file generator 141 and the XPS file generator 142 may be implemented in the form of a single filter in an XPS print filter pipeline of an XPS printer driver.

The search unit 150 may search for a region of an XPS file which satisfies document information conditions specified by a user. In more detail, if a user inputs a condition for a predetermined document information item, the search unit 150 may determine whether document information input by the user is set in the XPS file, and if so, may search for a region of the XPS file which satisfies the input condition. For example, when an XPS file contains ‘Korean weather’ (title) as document information of the job level, ‘summer weather’ (title) as first document information of the document level and ‘winter weather’(title) as second document information of the document level, if a user enters ‘winter’ as a search term for the title item, the search unit 150 may search for the second document region of the document level as a region of the XPS file which satisfies the term ‘winter.’

Additionally, the search unit 150 may search for an XPS file satisfying document information conditions specified by a user. For example, if a user enters ‘weather’ as a search term for the title item, the search unit 150 may search the storage unit 130 for an XPS file including document information entitled ‘weather.’ The search unit 150 may include, for example, program code stored in a data storage device, such as the storage unit 130. The program code may be executed by a processor and supporting logic circuitry to perform the above-described search. The processor and supporting circuitry may be part of the control unit 160 or the search unit 150 may include a dedicated processor and supporting circuitry.

The control unit 160 may control each of the constituents in the print control terminal device 100. In more detail, if a user enters a print command, an XPS file generation command, a document information input command or other commands through the user interface unit 120, the control unit 160 may control the user interface unit 120 to display a user interface window to receive document information input by the user. Additionally, the control unit 160 may control the driver unit 140 to generate an XPS file containing the document information input through the user interface unit 120.

Furthermore, the control unit 160 may control the communication interface unit 110 so that the generated XPS file may be transmitted to the image forming apparatus (not illustrated). More specifically, if the above-described process is performed in response to a user's print command, the control unit 160 may control the communication interface unit 110 to transmit the XPS file generated by the driver unit 140 to the image forming apparatus.

The control unit 160 may store the XPS file generated by the driver unit 140 in the storage unit 130. More specifically, an XPS file may be generated with a spool file format or a document file format, and thus may be repeatedly used. Accordingly, the control unit 160 may store the XPS file that is generated by the driver unit 140 and contains document information in the storage unit 130. In this situation, the control unit 160 may store the generated XPS file with a name selected by a user, and store the generated XPS file by overriding the original document. Such a storing operation may be performed according to user selection or automatically performed without any user command.

In addition, if a user enters document information conditions, the control unit 160 may control the search unit 150 to search for a region of an XPS file which satisfies the document information conditions entered by the user. Additionally, the control unit 160 may perform an operation selected by the user with respect to the region found as a result of a search by the search unit 150. For example, if the user selects a print option, the control unit 160 may set the selected print option to only the region found as a result of a search by the search unit 150. Additionally, if the user enters a print command, the control unit 160 may print only the selected region, or the region that corresponds to the previously-entered search command. Furthermore, if the user enters a storage command, the control unit 160 may change the XPS file so that the XPS file may contain only the region and the changed XPS file may be stored. In this situation, the changed XPS file may be stored with a different name, or stored by overriding the original XPS file. Such a storing operation may be performed according to user selection or automatically performed without any user command.

Alternatively, if a user enters document information conditions, the control unit 160 may search for an XPS file which satisfies the document information conditions entered by the user. In more detail, the control unit 160 may control the search unit 150 to search the storage unit 130 to determine presence or absence of the XPS file satisfying the document information conditions, and may control the user interface unit 120 to display the XPS file found as a result of searching. Additionally, the control unit 160 may perform an operation selected by the user with respect to only the XPS file found as a result of searching. For example, if the user selects printing, the control unit 160 may print only the XPS file.

The control unit 160 may include one or more processors, logic circuits, and memory devices to store data, execute commands, and to control the individual functional units of the print control terminal device 100.

As described above, the print control terminal device 100 according to the exemplary embodiment may generate an XPS file containing document information, and thus it is possible for a user to easily search for a desired XPS file from a plurality of XPS files. Additionally, the print control terminal device 100 may hierarchically add document information to PrintTickets, and it is therefore for a user to easily search for a desired region within an XPS file.

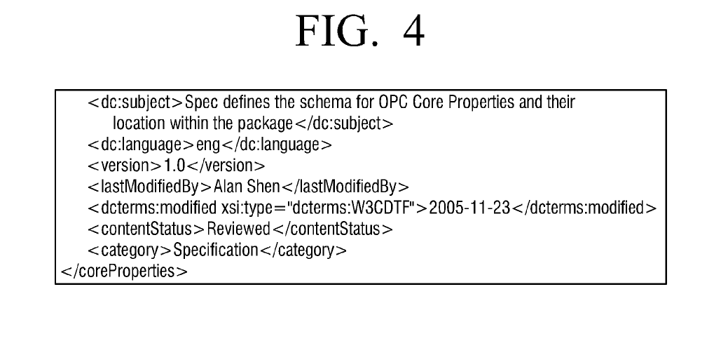

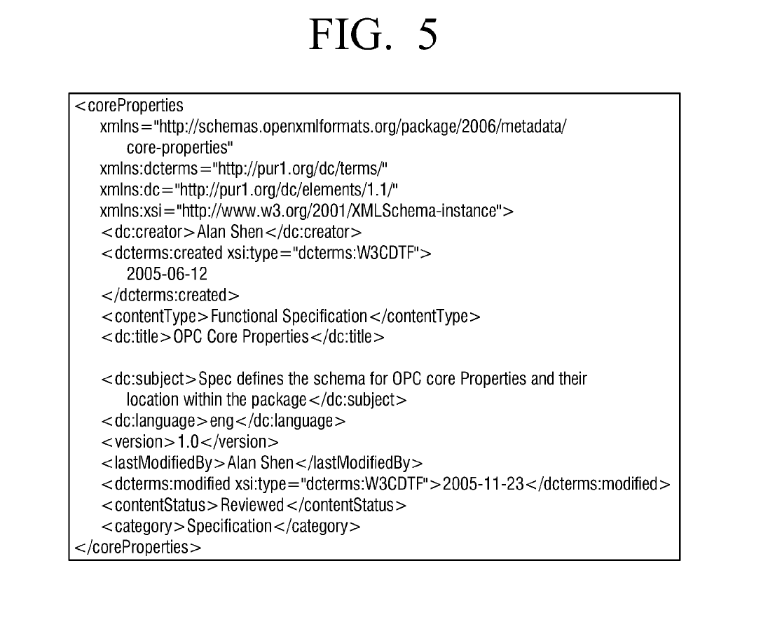

Hereinafter, the document information file generated by the document information file generator 141 will be described with reference to FIGS. 4 and 5.

FIG. 4 exemplarily illustrates a document information file, which is generated based on the OPC format by the document information file generator 141. As illustrated in FIG. 4, the generated document information file includes document information, for example information regarding a title, a subject, a language, a version, a user who last modified a document, and date and time when the document was last modified.

FIG. 5 exemplarily illustrates a document information file which is generated based on an office open XML format by the document information file generator 141. As illustrated in FIG. 5, the generated document information file includes document information, for example information regarding a creator, a user who last modified a document, a revision, date and time when the document was last printed, date and time when the document was created, and date and time when the document was last modified.

While two different formats are used to generate the document information files illustrated in FIGS. 4 and 5, there is no limitation thereto. Accordingly, various formats may be used to generate a document information file, instead of the OPC format.

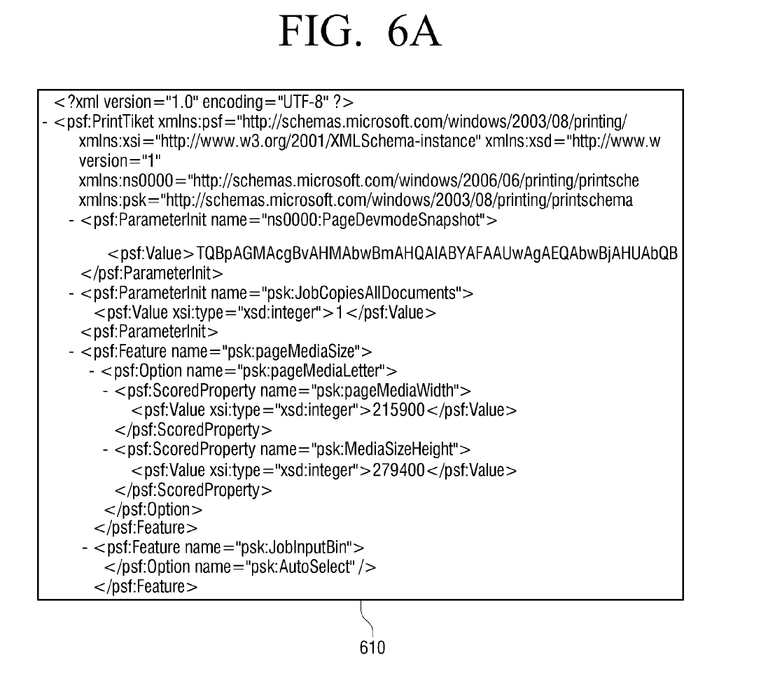

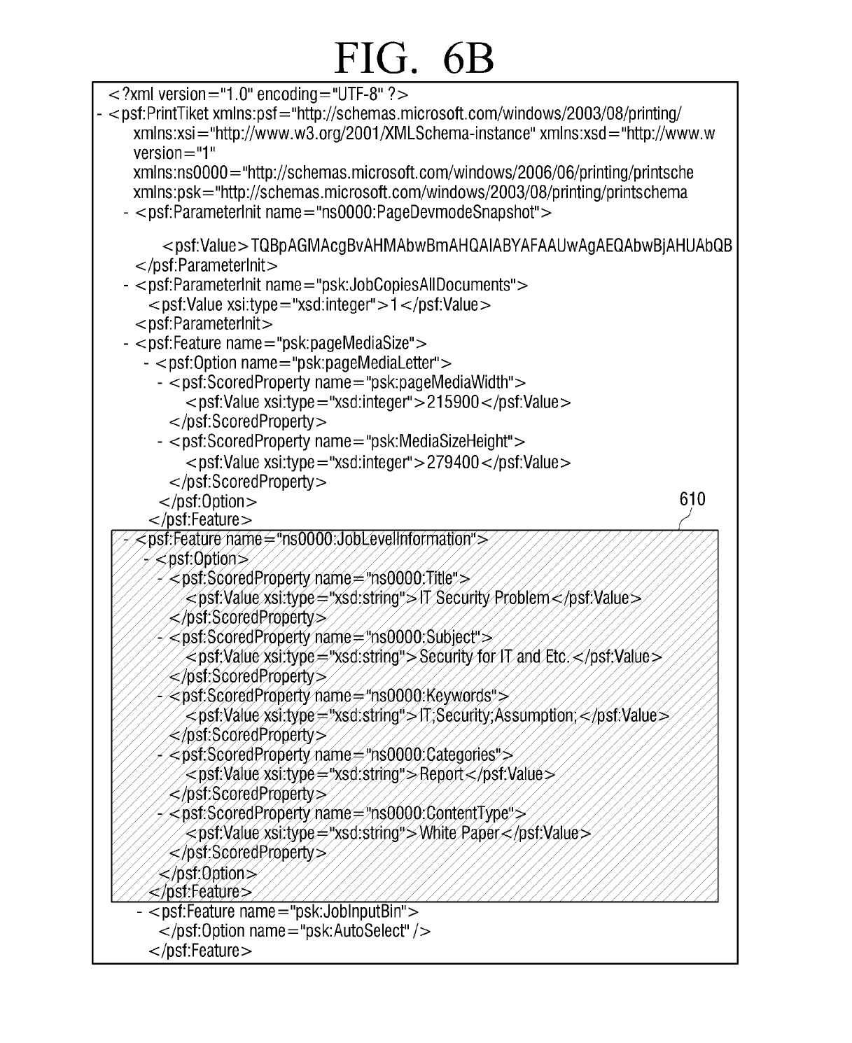

Hereinafter, the operation of the XPS file generator 142 will be described with reference to FIGS. 6A and 6B. FIG. 6A exemplarily illustrates a job-level PrintTicket before addition of document information, and FIG. 6B exemplarily illustrates a job-level PrintTicket after addition of document information.

As illustrated in FIGS. 6A and 6B, the XPS file generator 142 may add to the job-level PrintTicket of FIG. 6A document information of the document information file generated by the document information file generator 141 which is indicated by a box 610 of FIG. 6B. Referring to FIG. 6B, the document information in the box 610 may include information regarding title, subject, keywords, categories and content type.

The document information is added to the job-level PrintTicket as illustrated in FIGS. 6A and 6B, but may also be added to a document-level PrintTicket and a page-level PrintTicket as described above.

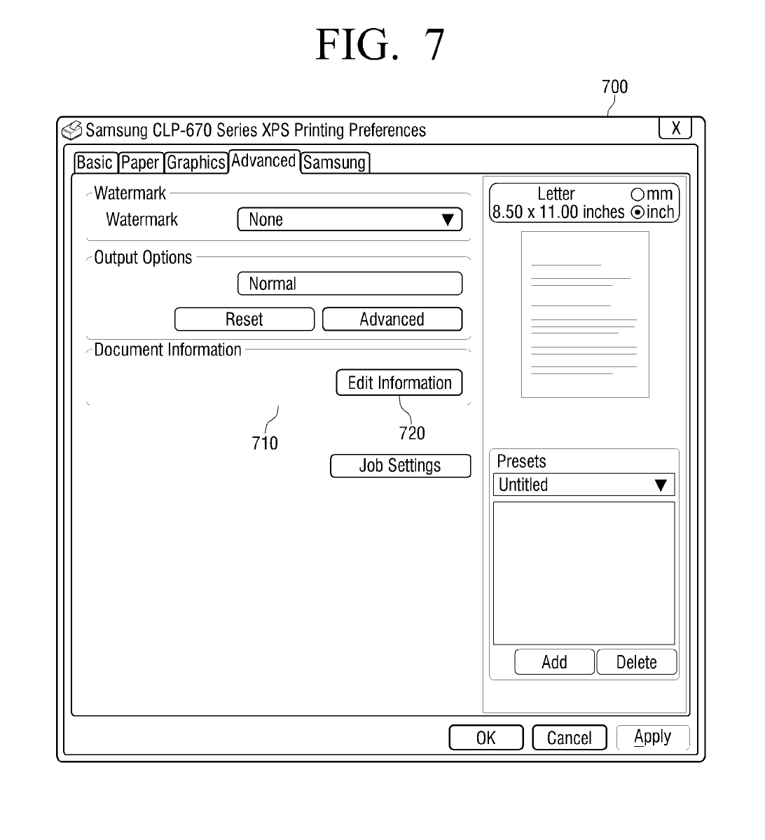

FIGS. 7 to 11 illustrate user interface windows 700 to 1100 according to an exemplary embodiment of the present general inventive concept.

As illustrated in FIG. 7, the user interface window 700 may be displayed to enable a user to set a variety of print options for a selected document. In more detail, the user interface window 700 may include an ‘Edit Information’ box 720 by which a user is able to enter a command to edit document information 710. In other words, a user may enter document information through the user interface window 700 by selecting the ‘Edit Information’ box 720. While the printer driver is used to receive the command to edit document information in the exemplary embodiment, other methods may be used to receive the command to edit document information.

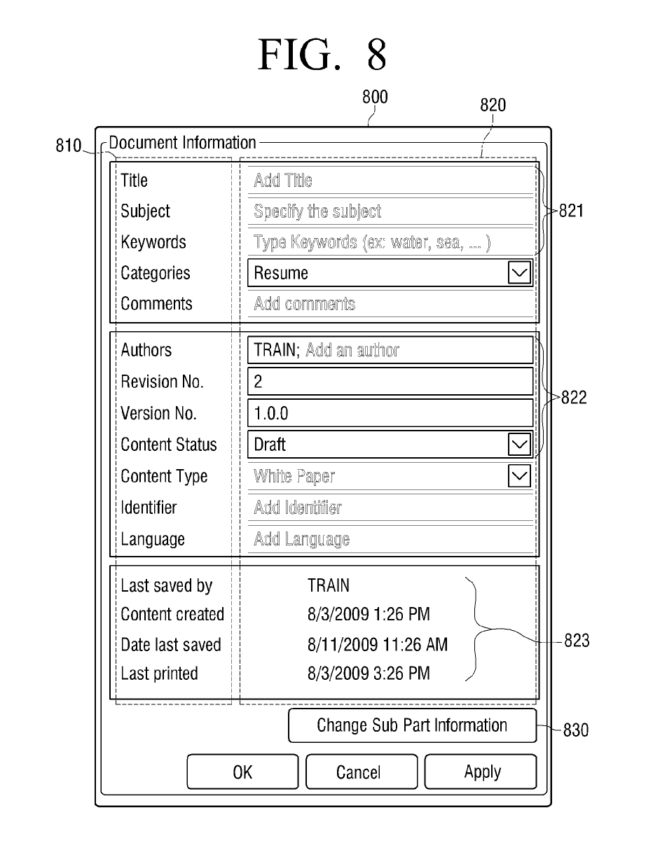

Referring to FIG. 8, the user interface window 800 may be displayed to receive document information input by a user. In more detail, the user interface window 800 may include a first field 810 to display a plurality of document information items in the form of a list, and a second field 820 to receive input of document information for each of the plurality of document information items. Accordingly, the user can easily input document information regarding a current document through the user interface window 800. The user interface window 800 of FIG. 8 displays sixteen document information items, but there is no limit to the number of document information items that may be displayed. Accordingly, other document information items may be added, or the order of document information items may be changed according to user settings and manufacturing settings.

In FIG. 8, the second field 820 is divided into three parts 821, 822, and 823. The preset document information may be reflected and displayed on a second part 822. Additionally, document information, for example information regarding the date and time when the document was last printed, the date and time when the document was last saved, and a user who last saved the document, may be reflected and displayed on a third part 823.

Moreover, a user may select a ‘Change Sub Part Information’ box 830 to hierarchically input document information.

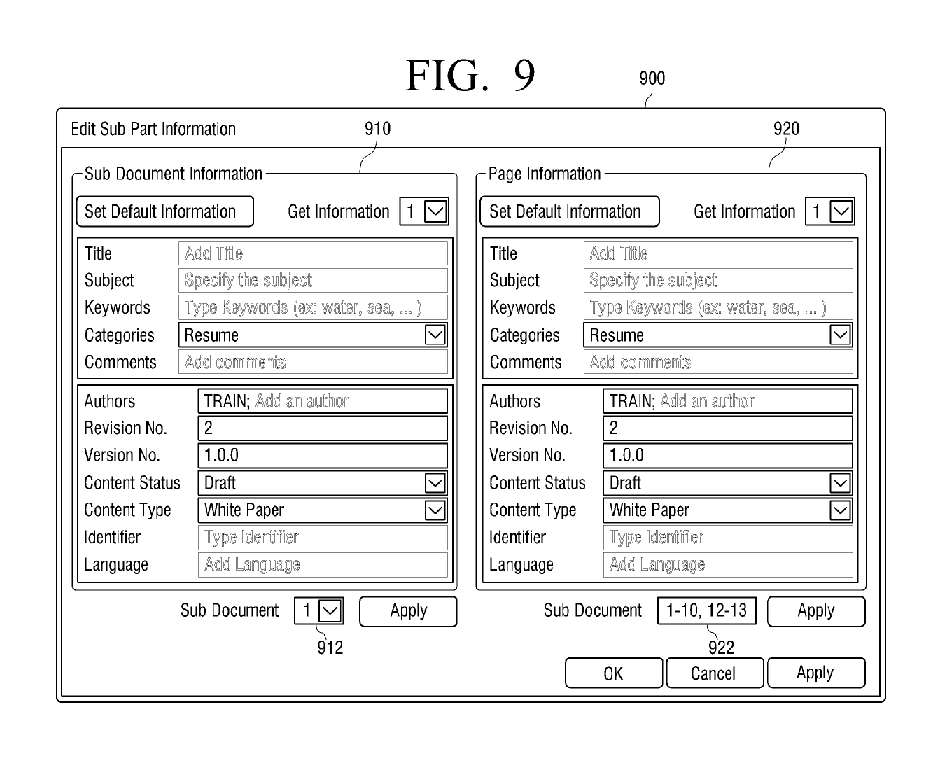

Referring to FIG. 9, the user interface window 900 may be displayed when a user selects the ‘Change Sub Part Information’ box 830 from the user interface window 800 of FIG. 8. The user interface window 900 may include a first field 910 to receive input of document information of a document level, and a second field 920 to receive input of document information of a page level. Each of the first field 910 and the second field 920 may include a first sub-field to display a plurality of document information items in the form of a list, and a second sub-field to receive input of document information for each of the plurality of document information items, in the same manner as shown in FIG. 8.

The user interface window 900 may also include a selection icon 912 to select a sub-document. For example, if the interface window 900 includes information corresponding to a print job including a document having multiple sub-documents, each having multiple pages, the selection icon 912 may allow a user to select one or more of the sub-documents and the user may configure settings for the selected sub-document only. The user interface window 900 may further include a selection icon or menu 922 to select a further sub-document, such as a page, of the sub-document selected by the selection icon or menu 912. In this manner, document information and settings may be adjusted for each hierarchal level of an XPS file.

Therefore, the user interface windows described above may make it easy for a user to hierarchically input document information.

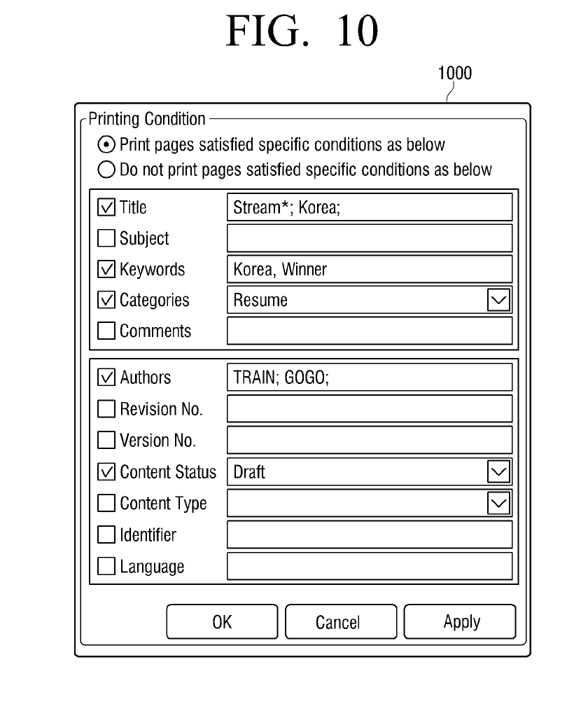

Referring to FIG. 10, the user interface window 1000 may be displayed to set a print region according to document information conditions specified by a user. More specifically, if the user enters document information conditions through the user interface window 1000, the search unit 150 may search for a region of an XPS file which satisfies the document information conditions specified by the user, and the control unit 160 may print the region found as a result of search by the search unit 150.

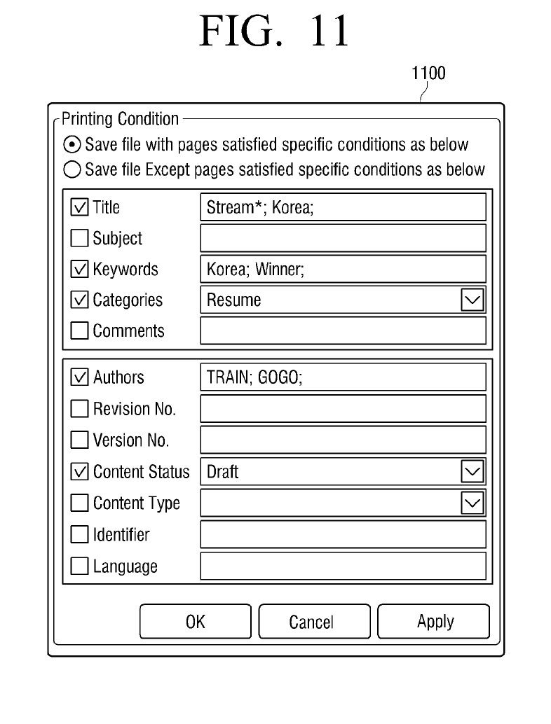

Referring to FIG. 11, the user interface window 1100 may be displayed to select a storage region according to document information conditions specified by a user. More specifically, if the user enters document information conditions through the user interface window 1100, the search unit 150 may search for a region of an XPS file which satisfies the document information conditions specified by the user, and the control unit 160 may control the storage unit 130 to store only the region found as a result of search by the search unit 150.

Therefore, it is possible for a user to easily search for a desired region in an XPS file through the user interface windows 1000 and 1100, thereby increasing user convenience.

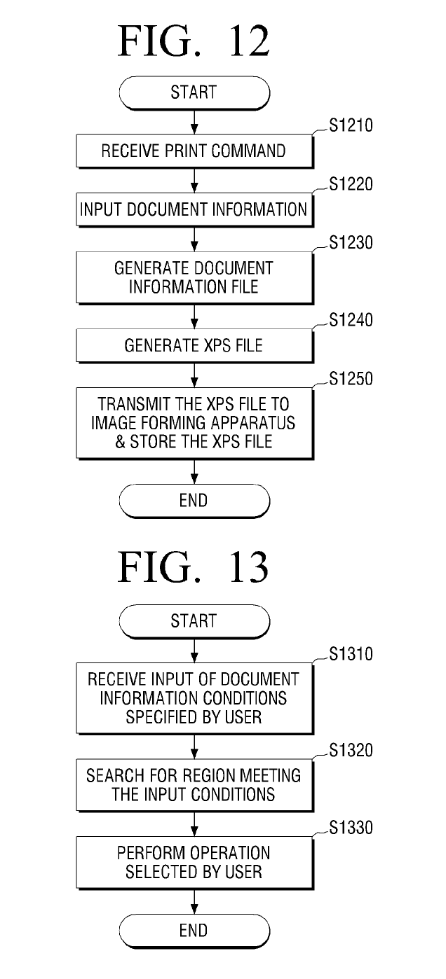

FIG. 12 is a flowchart illustrating a print control method according to an exemplary embodiment of the present general inventive concept.

In FIG. 12, a print command is received to print a document in operation S1210, and document information regarding the document is received from a user in operation S1220. In more detail, if the command to print the document is received from the user, a user interface window may be displayed. The displayed user interface window may include, as described above, a first field to display a plurality of document information items in the form of a list so as to receive information on the plurality of document information items input by the user, and a second field to receive document information for each of the plurality of document information items input by the user. Additionally, document information, for example information regarding the date and time when the document was last printed, the date and time when the document was last saved, and a user who last saved the document, may be reflected and displayed on the list of the user interface window. Accordingly, the user may input the document information through the user interface window.

As described above, since an XPS file has a hierarchical branching structure as described above, the document information may also be hierarchically reflected on the XPS file. Accordingly, the plurality of document information items input by the user may be hierarchically received. For example, if an XPS file has two document levels, a job level titled as ‘Korean weather’ and document levels, which are lower than the job level and titled as ‘summer weather’ and ‘winter weather,’ may be received through the user interface window.

Subsequently, in operation S1230, a document information file is generated using the received document information. In operation S1230, a core properties file containing the document information items input by the user is generated.

In more detail, if the document information is hierarchically received from the user, the document information items may be hierarchically classified, so that a plurality of document information files may be generated to correspond to each of the classified items. For example, if a user enters ‘Korean weather’ as a title for a job level and enters ‘summer weather’ and ‘winter weather’ as titles for lower document levels, the document information file generator 141 may generate a first document information file corresponding to the job level titled as ‘Korean weather’, a second document information file corresponding to the document level titled as ‘summer weather’ and a third document information file corresponding to the document level titled as ‘winter weather.’

After operation S1230, an XPS file containing the generated document information files is generated in operation S1240. More specifically, if the print command is applied to an XPS file, the generated document information files may be added to PrintTickets corresponding to one or more levels of the XPS file, so that an XPS file containing the document information may be generated. For example, if a first document information file corresponding to the job level, and a second document information file and third document information file corresponding to the document levels are generated in operation S1230, document information of the first document information file, document information of the second document information file, and document information of the third document information file may be added to a job-level PrintTicket, a first document-level PrintTicket, and a second document-level PrintTicket within the XPS file, respectively.

If the print command is applied to a document other than the XPS file, the document may be converted into an XPS file, and then the document information of the document information file may be added to a PrintTicket within the XPS file.

Additionally, if the XPS file does not contain PrintTicket corresponding to the document information file, a PrintTicket corresponding to the document information file may be generated, and then the document information of the document information file may be added to the generated PrintTicket.

The generated XPS file is transmitted to an image forming apparatus in operation S1250.

In addition, the generated XPS file may be stored, in order to repeatedly print the XPS file containing the document information. In this situation, the generated XPS file may be stored with a name selected by a user, and stored by overriding the original document. Such a storing operation may be performed according to user selection or automatically performed without any user command.

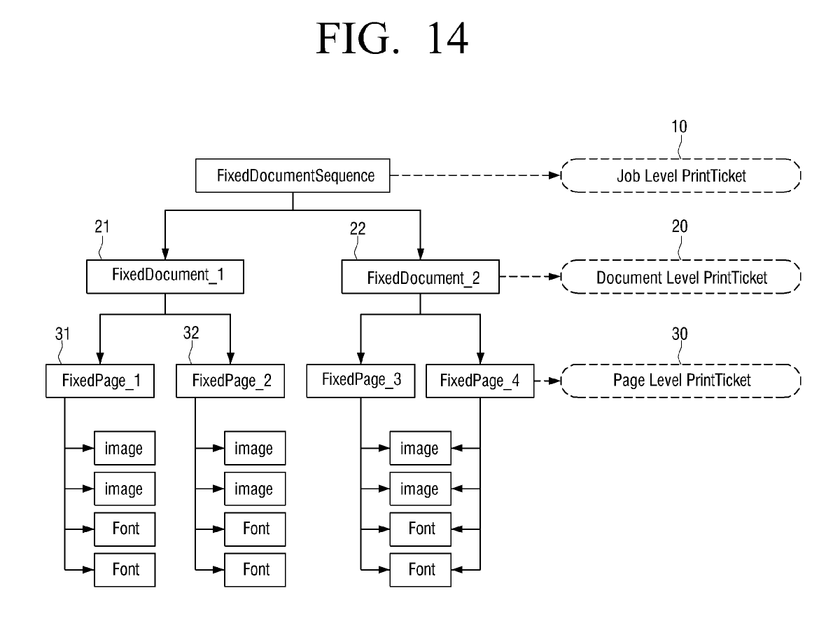

FIG. 13 is a flowchart illustrating a print control method using the XPS file generated by the print control method of FIG. 12.

In FIG. 13, if document information conditions are specified by a user in operation S1310, a region of an XPS file which satisfies the document information conditions is searched for in operation S1320. More specifically, if a user enters document information conditions, then it may be determined whether document information satisfying the document information conditions is set in the XPS file. If it is determined that the document information satisfying the document information conditions is set in the XPS file, a region corresponding to a PrintTicket containing the set document information is searched for within the XPS file. For example, when an XPS file contains ‘Korean weather’ (title) as document information of the job level, ‘summer weather’ (title) as first document information of the document level and ‘winter weather’ (title) as second document information of the document level, if a user enters ‘winter’ as a search term for the title item, the second document region of the document level may be found as a region of the XPS file which satisfies the term ‘winter.’

Subsequently, an operation selected by the user is performed in operation S1330. In more detail, the operation selected by the user may be performed with respect to the region found as a result of searching in operation S1320. For example, the user selects a print option, the selected print option may be set to only the region found as a result of searching. Additionally, if the user enters a print command, only the region found as a result of searching may be printed. Furthermore, if the user enters a storage command, the XPS file may be changed so that the XPS file may contain only the region found as a result of searching, and the changed XPS file may be stored. In this situation, the changed XPS file may be stored with a different name, or stored by overriding the original XPS file. Such a storing operation may be performed according to user selection or automatically performed without any user command.

Searching for a predetermined region within a single XPS file has been described with reference to FIG. 13, but an XPS file satisfying the document information conditions specified by the user may also be searched for.

Therefore, in the print control method according to the exemplary embodiments of the present general inventive concept, an XPS file containing document information may be generated, and thus it is possible for a user to easily search for a desired XPS file from a plurality of XPS files. Additionally, the document information may be hierarchically added to PrintTickets, and thus it is possible for a user to easily search for a desired region within an XPS file, and perform a desired operation with respect to the desired region. The print control methods of FIGS. 12 and 13 may be performed by a print control terminal device configured as shown in FIG. 1, or other print control terminal devices.

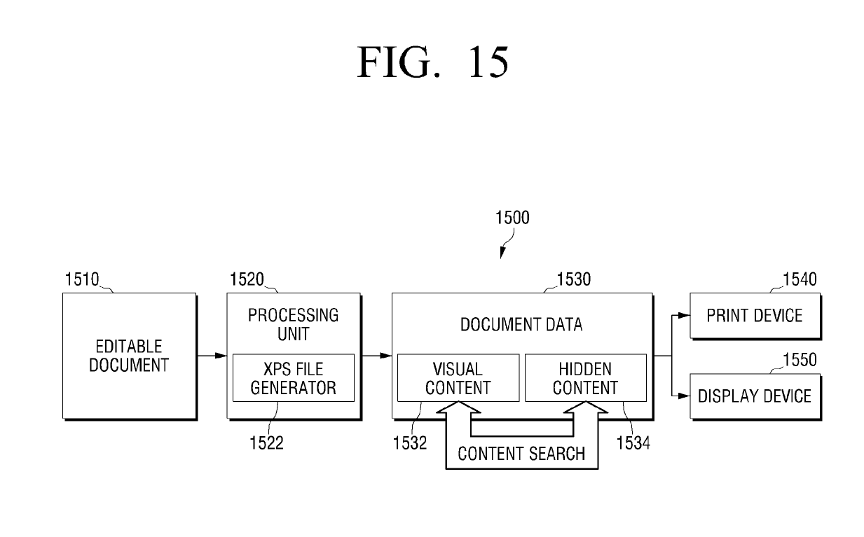

FIG. 15 illustrates an example of an XPS file 1500 generated according to an embodiment of the present general inventive concept. A user or program may generate document data in an editable document 1510, such as text, graphics, pictures, etc. that may be changed and viewed in a processing program such as a word processing program, a graphics program, or any other program capable of editing documents. When the user or program has finished entering data, the user or program may direct a processing unit 1520, such as the control unit 160 and the driver unit 140 of FIG. 1. The processing unit 1520 may include an XPS file generator 1522, or may be connected to the XPS file generator 1522, to generate an XPS file 1500 of the editable document 1510. The processing unit may generate an XPS file having one or more documents and sub-documents, each having fixed characteristics. For example, a user may select two word processing files to generate an XPS file, and the processing unit may generate an XPS file to display each of the two word processing files as separate documents in the XPS file. The visual content of the two word processing files may be displayed as viewable in the respective documents of the XPS file.

Alternatively, a single word-processing document, graphics document, or other file may be sub-divided into multiple sub-documents. For example, a job-level document may include chapter or section sub-documents within the job-level document, and page sub-documents within the chapter sub-documents.

As illustrated in FIG. 15, the XPS file 1500 may include data 1530 corresponding to the fixed visual content 1532 of the document and hidden content 1534 of the document. The visual content 1532 may correspond to the visual elements of the editable document 1510 that have been converted into non-alterable or fixed objects or segments. The hidden content 1534 may include print settings, heading information, content information, user information, as well as other programming code to allow devices to recognize, display, and/or print the XPS file 1500. The hidden content 1534 may be generated by generating PrintTickets to correspond to the document, for example.

Upon generating the XPS file 1500, the processing unit 1520 may prompt a user to input hidden content data 1514 or hidden content data may be automatically generated. For example, as illustrated above in FIGS. 8 and 9, a user may be prompted to enter a title, subject, keywords, and other data corresponding to the job level document or to sub-documents, such as pages of the job-level document. Alternatively, the processing unit may automatically enter default settings based on predetermined or pre-entered data.

After the XPS file 1500 is generated, a user may search for data in the XPS file 1500 corresponding to the hidden content 1514, such as the title, subject, or keywords. According to another embodiment, a user may also search for data corresponding to visual content 1512 of the XPS file 1500.

The non-alterable, searchable XPS document 1500 may be transmitted to one or more print devices 1540 or display devices 1550. The print devices 1540 or display devices 1550 may respectively print or display only the visual content 1532 of the XPS document 1500. In addition, as discussed above, the printed or displayed content may change depending upon the results of a search.

According to another exemplary embodiment of the present general inventive concept, the hidden content 1534 of an XPS file 1500 may be displayed and/or modified after the XPS file 1500 is generated, while the visual content 1532 remains unchanged.

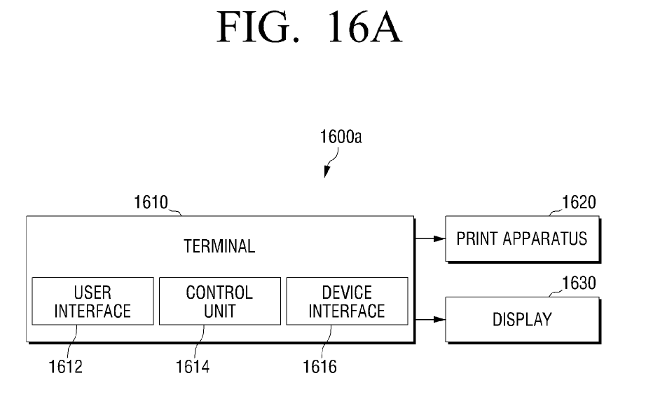

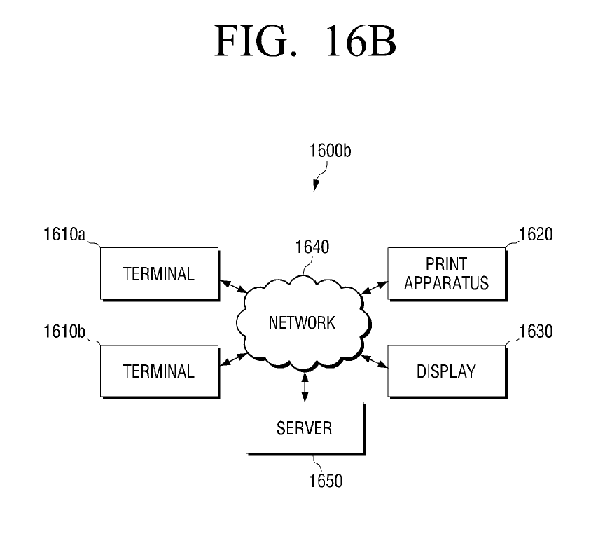

FIGS. 16A and 16B illustrate systems to generate, print, and display XPS files according to embodiments of the present general inventive concept.

FIG. 16A illustrates a system 1600a including a terminal 1610 including a user interface 1612 to receive user input and to output data to a user, a control unit 1614, and a device interface 1616 to communicate with external devices. The terminal 1610 is connected to a print apparatus 1620 to print data generated or stored in the terminal 1610. The terminal 1610 may also be connected to an external display 1630 to display data generated or stored in the terminal 1610. The control unit 1614 may be similar to the control unit 160, storage unit 130, and driver 140 illustrated in FIG. 1, for example. In other words, the control unit 1614 may include one or more processors, one or more data storage devices, and one or more logic circuits to process and store data and to execute commands stored in the data storage devices and generated by the user interface 1612 or received via the device interface 1616.

The terminal 1610 may be directly connected to one or more external devices to print or display the XPS document via a wired connection or a wireless connection.

FIG. 16B illustrates a system 1600b including a first terminal 1610a to generate an XPS file or to generate a command to control the server 1650 to generate the XPS file. Once the XPS file is generated, it may be transmitted via the network 1640 to a second terminal 1610b, a print apparatus 1620, a display 1630, or any other device connected to the network 1640. Once generated, the XPS file may be stored on either one of the terminals 1610a and 1610b or the server 1650. If the XPS file is stored in the server 1650, each of the terminals 1610a and 1610b may access the XPS file via the network 1640. For example, a user of the terminal 1610b may initiate a search of XPS files stored on the server 1650 by searching data entered by a user of the terminal 1610a upon generation of the XPS file as described above with reference to FIGS. 8 and 9.

In addition, if the XPS file is stored on the server 1650, either one of the terminals 1610a and 1610b may initiate a printing or display function to print the visual data of the XPS file on the print apparatus 1620 or to display the visual data of the XPS file on the display 1630.

The above embodiments of the present general inventive concept provide a method and apparatus to generate an XPS file to present a visible display to a user and to allow a user or device to insert additional searchable document information into the XPS file to allow a user or device to search the XPS file for particular content or characteristics. In other words, because an XPS file generates a fixed visible image, it may be difficult or impossible to search the content of the XPS file for particular data. In addition, the above embodiments of the present general inventive concept allow a user or device to add additional document information to an XPS file, such as keywords, subject, or other information that may not be in the visible content but may allow a user or device to locate other data in within the visible content.

For example, if a page of an XPS file describes a particular weather pattern such as “rainy” but does not specifically refer to the word “weather,” the present general inventive concept may allow a user or device to associate a searchable keyword or subject “weather” with the page, so that a user or device would find the page if the user or device ran a search including the term “weather.” Thus, the present general inventive concept provides a method and apparatus to search for content located within the visible content of the XPS document by using terms that are found within the visible content, related to the visible content, or otherwise associated with the visible content by a user or device. However, the document information itself may be invisible to a user or device when the XPS document is displayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A print control method in a print control terminal device connected to an image forming apparatus, the print control method comprising:
receiving a print command to print a document;
after receiving the print command, receiving an input of document information regarding the document;
generating a document information file using the input document information;
generating an XML paper specification (XPS) file containing the document information using the generated document information file; and
transmitting the generated XPS file to the image forming apparatus.

2. The print control method as claimed in claim 1, wherein the receiving of the input of the document information comprises:
displaying a plurality of document information items in the form of a list; and
receiving an input of document information regarding at least one item of the plurality of displayed document information items.

3. The print control method as claimed in claim 2, wherein the receiving of the input of the document information further comprises:
recognizing a document information item previously set in a document to which the print command is applied,
wherein the displaying of the plurality of document information items comprises reflecting and displaying the recognized document information item on the list.

4. The print control method as claimed in claim 1, wherein the receiving of the input of the document information comprises receiving a hierarchical input of a plurality of document information items.

5. The print control method as claimed in claim 4, wherein the generating of the document information file comprises hierarchically generating a plurality of document information files to correspond to the plurality of hierarchically input document information items.

6. The print control method as claimed in claim 5, wherein the generating of the XPS file comprises adding the plurality of hierarchically generated document information files to one or more PrintTickets that correspond to one or more levels within the XPS file and generating the XPS file containing the document information.

7. The print control method as claimed in claim 4, wherein the one or more levels are a job level, a document level, and a page level.

8. The print control method as claimed in claim 1, wherein the generating of the XPS file comprises:
if the print command is applied to a document other than the XPS file, converting the document into an XPS file; and
adding the generated document information file to the XPS file.

9. The print control method as claimed in claim 1, further comprising:
storing the generated XPS file.

10. The print control method as claimed in claim 1, further comprising:
receiving a document information condition specified by a user; and
searching for a region of an XPS file which satisfies the document information condition.

11. The print control method as claimed in claim 10, further comprising:
setting a print option selected by the user to the region found as a result of searching.

12. The print control method as claimed in claim 10, wherein the transmitting of the generated XPS file comprises setting the region found as a result of searching to be a print range and transmitting the generated XPS file to the image forming apparatus in the set print range.

13. The print control method as claimed in claim 10, further comprising:
storing only the region found as a result of searching.

14. A print control terminal device connected to an image forming apparatus, the print control terminal device comprising:
a user interface unit to receive a print command to print a document and, after receiving the print command, to receive an input of document information regarding the document;
a document information file generator to generate a document information file using the input document information;
an XML paper specification (XPS) file generator to generate an XPS file containing the document information using the generated document information file; and
a communication interface unit to transmit the generated XPS file to the image forming apparatus.

15. The print control terminal device as claimed in claim 14, wherein the user interface unit displays a plurality of document information items in the form of a list, and receives an input of document information regarding at least one item of the plurality of displayed document information items.

16. The print control terminal device as claimed in claim 15, wherein the user interface unit recognizes a document information item previously set in a document to which the print command is applied, and reflects and displays the recognized document information item on the list.

17. The print control terminal device as claimed in claim 14, wherein the user interface unit receives a hierarchical input of a plurality of document information items.

18. The print control terminal device as claimed in claim 17, wherein the document information file generator hierarchically generates a plurality of document information files to correspond to the plurality of hierarchically input document information items.

19. The print control terminal device as claimed in claim 17, wherein the XPS file generator adds the plurality of hierarchically generated document information files to one or more PrintTickets that correspond to one or more levels within the XPS file and generates the XPS file containing the document information.

20. The print control terminal device as claimed in claim 17, wherein the one or more levels are a job level, a document level, and a page level.

21. The print control terminal device as claimed in claim 14, wherein, if the print command is applied to a document other than the XPS file, the XPS file generator converts the document into an XPS file, and
wherein the XPS file generator adds the generated document information file to the XPS file.

22. The print control terminal device as claimed in claim 14, further comprising:
a storage unit to store the generated XPS file.

23. The print control terminal device as claimed in claim 14, further comprising:
a search unit to search for a region of an XPS file which satisfies a document information condition specified by a user.

24. The print control terminal device as claimed in claim 23, further comprising:
a control unit to set a print option selected by the user to the region found as a result of searching.

25. The print control terminal device as claimed in claim 23, wherein the communication interface unit sets the region found as a result of searching to be a print range and transmits the generated XPS file to the image forming apparatus in the set print range.

26. An XML paper specification (XPS) file generation terminal, comprising:
a user interface to receive data to display in an editable document;
a controller to receive a command to generate an XPS file and, after receiving the command, to receive document information to include in the XPS file; and
an XPS file generator to generate an XPS file including visible data corresponding to the displayed data of the editable document and the non-displayed document information.

27. The XPS file generation terminal according to claim 26, wherein the XPS file generator generates the XPS file to include a plurality of hierarchal levels, and
each of the visible data and the document information includes different data to correspond to different hierarchal levels of the plurality of hierarchal levels.

28. The XPS file generation terminal according to claim 26, further comprising:
a communication interface to output the XPS file to an external device.

29. The XPS file generation terminal according to claim 26, wherein the controller receives the document information via the user interface.

30. The XPS file generation terminal according to claim 26, wherein the document information includes at least one of a subject, keyword, or comment corresponding to the XPS file.

31. An XML paper specification (XPS) file generation terminal, comprising:
a controller to receive a command to generate an XPS file and, after receiving the command, to receive document information to include in the XPS file; and
an XPS file generator to generate an XPS file including visible data corresponding to the print command and the document information.

32. A computing system, comprising:
a first terminal to receive a command to generate an XPS file to display original data, to receive document information to include in the XPS file after receiving the first command, and to generate the XPS file including the original data and the document information; and
a display device connected to the first terminal to display the original data of the XPS file.

33. The computing system according to claim 32, wherein the display device is a printer, and
the printer prints only the original data of the XPS file.

34. The computing system according to claim 32, wherein the display device is a video display device to display only the original data of the XPS file.

35. The computing system according to claim 32, further comprising:
a second terminal connected to the first terminal, the second terminal to receive the XPS file and including a display,
wherein at least one of the first terminal and the second terminal includes a search unit to fine at least one datum of the document information based on a user input.

36. The computing system according to claim 35, wherein the at least one of the first and second terminal includes a communication interface unit to output an original datum corresponding to the at least one datum of the document information to at least one of a printer and a video display device.
